(19) United States
(12) Patent Application Publication
(10) Pub. No.: US 2019/0158708 A1
(43) Pub. Date: May 23, 2019

(54) INDUCTIVE AND MULTI-VIEW VIRTUAL REALITY PANORAMIC VIDEO RECORDING PLATFORM WITH A TRAVELLING MECHANISM

(71) Applicant: Wai Hung CHEUNG, Hong Kong (HK)

(72) Inventor: Wai Hung CHEUNG, Hong Kong (HK)

(21) Appl. No.: 15/848,242

(22) Filed: Dec. 20, 2017

(30) Foreign Application Priority Data
Nov. 23, 2017 (CN) 201711183651.9

(51) Int. Cl. H04N 5/225; H04N 5/232; H04N 5/28

(52) U.S. Cl. CPC H04N 5/2252; H04N 5/23238; H04N 13/0203; H04N 5/2257; H04N 5/28; H04N 5/2258

(57) ABSTRACT

The invention relates to an inductive and multi-view virtual reality panoramic video recording platform with a travelling mechanism of the invention which includes a base, a telescopic device, a damped turntable, and an amounting bracket. The base includes a base plate, a cylinder, and a travelling mechanism with track. The telescopic device includes a sleeve, a movable rod, a mounting bolt and a foldable pole. The damped turntable includes a fixed chassis, a rotating disk and a winding spring. The fixed chassis is rotably connected to the rotating disk through a shaft disposed on the rotating disk. The winding spring is disposed in the cavity between the fixed chassis and the rotating disk. The mounting bracket includes a support plate vertically fixed on the rotating disk, a transversely-arranged damped axis, and a mounting plate. The inductive and multi-view virtual reality panoramic video recording platform with a travelling mechanism of the invention has advantages of having simple and reasonable structures, being easy to use and put away, and portable. It effectively solves the problem regarding the inconvenience of existing camera devices during travelling shot.

### FIELD OF THE INVENTION

The invention relates to imaging equipment. In particular, the invention relates to an inductive and multi-view virtual reality panoramic video recording platform with a travelling mechanism.

### BACKGROUND

A camera is a tool that transforms optical image signals into electrical signals for storage or transmission. When we shoot an object, the light reflected by the object is collected by the camera lens to focus on the light-receiving surface of the camera device, and then converted the light into electricity by the camera device to obtain the “video signal”.

Traditional mobile shots and follow shots can be generally divided into two ways. One is to directly rely on cameraman by means of hand-held video camera to complete. This requires high cameraman's skills and anti-shake performance of the camera. Professionals are required to compose view, and shoot in a steady way. Another way is to use professional slide rails and rail cars to shoot. This requires many equipment and related personnel to operate which is more complicated. In addition, cameras are often required to be rotated during shooting. In the known art, a rotating supporter is provided with a turntable with a scale. It is inconvenient to read the rotation angle manually.

### SUMMARY OF THE INVENTION

The technical problem to be solved is to overcome the above-mentioned deficiency by providing an inductive and multi-view virtual reality panoramic video recording platform with a travelling mechanism. It has advantages of having simple and reasonable structures, being easy to use and put away, and portable. It effectively solves the problem regarding the inconvenience of existing camera devices during travelling shot.

The technical solution of the invention provides an inductive and multi-view virtual reality panoramic video recording platform with a travelling mechanism, which includes a base, a telescopic device, a damped turntable, and an amounting bracket. The base includes a base plate, a cylinder and a travelling mechanism with track. The base plate is fixedly disposed at two ends of the cylinder, respectively. The travelling mechanism with track is connected with the base plate.

The telescopic device includes a sleeve fixed at the base, a movable rod sleeved with the sleeve, a mounting bolt and a foldable pole. The movable rod is provided with a plurality of first bolt holes. The sleeve is provided with second bolt holes that correspond to the first bolt holes. The mounting bolt passes through the first bolt hole and the second bolt hole to fix the sleeve and the movable pole.

The damped turntable includes a fixed chassis, a rotating disk and a winding spring. The fixed chassis is connected to the movable rod through a plug. The fixed chassis is rotably connected to the rotating disk through a shaft disposed on the rotating disk. The winding spring is disposed in the cavity between the fixed chassis and the rotating disk. One end of the winding spring is fixedly connected to the fixed chassis. Another end of the winding spring is fixedly connected to the shaft.

The mounting bracket includes a support plate vertically fixed on the rotating disk, a transversely-arranged damped axis, and a mounting plate. One end of the damped axis is connected to the support plate. Another end of the damped axis is fixedly connected to the mounting plate.

The fixed chassis is provided with a pressure-sensitive display. The rotating disk is provided with a protrusion. The protrusion is provided with a runner that abuts the pressure-sensitive display. The rotating disk is provided with a liquid crystal display. The pressure-sensitive display and the liquid crystal display are connected to external display controllers, respectively.

In a further embodiment, the travelling mechanism with track include a track, a track pulley, a track pulley support, and a driving mechanism that is fixed on the base plate. The track pulley support is fixedly connected to the base plate. The track pulley is disposed on the track pulley support. The track is disposed on the track pulley. The driving mechanism transmits to connect with the track pulley.

In a further embodiment, a chute is vertically disposed in the sleeve. A sliding block that is adapted to the chute is vertically disposed on the movable rod.

In a further embodiment, the sleeve is made from carbon structural steel. The movable rod is made from magnetized carbon structural steel.

In a further embodiment, the foldable pole includes a first folding board, and a second folding board. One end of the first folding board is hinged with one end of the second folding board through a hinge axis. Another end of the first folding board and another end of the second folding board are hinged with the sleeve, respectively.

In a further embodiment, the first folding board and the second folding board are made from L-shaped steel plate.

In a further embodiment, the shaft and the rotating disk are one-piece structure.

In a further embodiment, the rotating disk is provided with a connecting hole that is used to connect a handle. A first tooth socket is disposed in the connecting hole.

In a further embodiment, one end of the handle that connects to the connecting hole is provided with a second tooth socket. The first tooth socket mesh with the second tooth socket.

Compared with the prior art, the technical effect of the invention is to provide an inductive and multi-view virtual reality panoramic video recording platform with a travelling mechanism, which includes a base, a telescopic device, a damped turntable, and an amounting bracket. The base includes a base plate, a cylinder that connects to the base plate, and a travelling mechanism with track. The travelling mechanism with track moves the entire platform. The base plate connects to the cylinder. The base can be fold or unfold by the movement of the cylinder. The telescopic device easily adjusts the height of the damped turntable. A winding spring is disposed in the damped turntable to generate a certain damping to the rotation of the camera in the horizontal direction. A damped shaft on the mounting bracket connects to the camera, generating a certain damping to the rotation of the camera in the vertical direction. The damping in the horizontal and vertical directions prevents the camera from shaking significantly when the camera is operated. In addition, the damped turntable is provided with a pressure-sensitive display. The pressure-sensitive display detects the rotation angle of the damped turntable and show the result on the liquid crystal display. Users do not need to read the rotation angle by the scale. It has advantages of having simple and reasonable structures, being easy to use and put away, and portable. It effectively solves the problem regarding the inconvenience of existing camera devices during travelling shot.

### BRIEF DESCRIPTION OF THE DRAWINGS

The invention is illustrated by the following figures and embodiments.

FIG. 1 shows a front view of whole structure of an inductive and multi-view virtual reality panoramic video recording platform with a travelling mechanism in accordance with an example embodiment.

FIG. 2 shows a left view of whole structure of an inductive and multi-view virtual reality panoramic video recording platform with a travelling mechanism in accordance with an example embodiment.

FIG. 3 shows a schematic diagram of a base of an inductive and multi-view virtual reality panoramic video recording platform with a travelling mechanism in accordance with an example embodiment.

FIG. 4 shows a schematic diagram of a foldable pole of an inductive and multi-view virtual reality panoramic video recording platform with a travelling mechanism in accordance with an example embodiment.

FIG. 5 shows a schematic diagram of a damped turntable of an inductive and multi-view virtual reality panoramic video recording platform with a travelling mechanism in accordance with an example embodiment.

FIG. 6 shows a schematic diagram of a top view of a damped turntable of an inductive and multi-view virtual reality panoramic video recording platform with a travelling mechanism in accordance with an example embodiment.

FIG. 7 shows a schematic diagram of the connection between a handle and a connecting hole of an inductive and multi-view virtual reality panoramic video recording platform with a travelling mechanism in accordance with an example embodiment.

FIG. 8 shows a schematic diagram of a mounting bracket of an inductive and multi-view virtual reality panoramic video recording platform with a travelling mechanism in accordance with an example embodiment.

The reference numbers of the figures are as follows:

1: base; 11: base plate; 12: cylinder; 13: travelling mechanism with track; 131: track; 132: track pulley; 133: track pulley support; 14: motor mechanism; 2: telescopic device; 21: sleeve; 22: movable rod; 23; mounting bolt; 24: foldable pole; 241: first folding board; 242: second folding board; 243: hinge axis; 25: first bolt hole; 26: second bolt hole; 3: damped turntable; 311: rotating disk; 312: fixed chassis; 313: shaft; 314: winding spring; 315: plug; 316: pressure-sensitive display; 317: protrusion; 318: runner; 319: liquid crystal display; 32: handle; 321: second tooth socket; 33: connecting hole; 331: first tooth socket; 4: mounting bracket; 41: support plate; 42: damped axis; 43: mounting plate.

### DETAILED DESCRIPTION

The invention is illustrated in accordance with figures. The figures as simplified diagrams demonstrate the basic structures of the apparatus of embodiments of the invention. Thus, the invention is not limited to the figures.

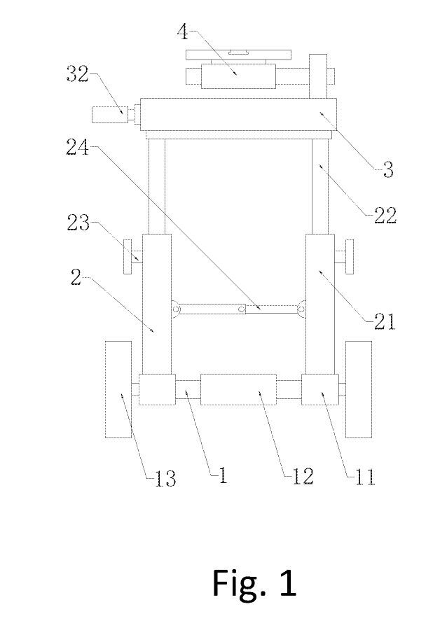

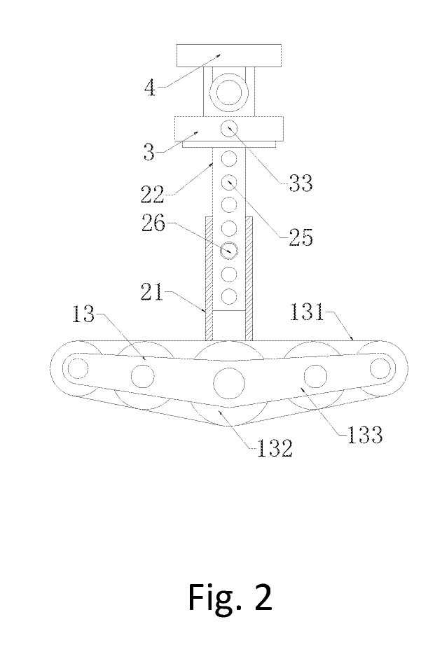

FIGS. 1 and 2 show an inductive and multi-view virtual reality panoramic video recording platform with a travelling mechanism which includes a base 1, a telescopic device 2, a damped turntable 3 and a mounting bracket 4.

The telescopic device 2 includes a sleeve 21 that is fixed on the base 1, a movable rod 22 sleeved with a sleeve 21, a mounting bolt 23, and a foldable pole 24. The movable rod 22 is provided with a plurality of first bolt holes 25. The sleeve 21 is provided with second bolt holes 26 that correspond to the first bolt holes 25. The mounting bolt 23 passes through the first bolt hole 25 and the second bolt hole 26 to fix the sleeve 21 and the movable pole 22.

In an embodiment, a chute is vertically disposed in the sleeve 21. A sliding block that is adapted to the chute is vertically disposed on the movable rod 22. In another embodiment, the sleeve 21 is made from carbon structural steel. The movable rod 22 is made from magnetized carbon structural steel.

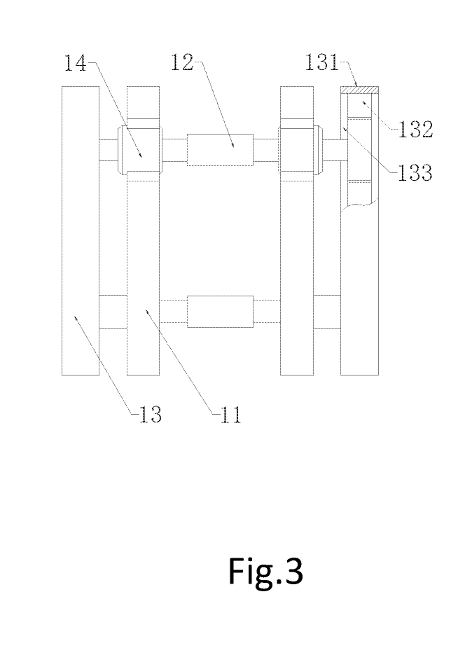

As shown in FIG. 3, the base includes a base plate 11, a cylinder 12 and a travelling mechanism with track 13. The base plate 11 is fixedly disposed at two ends of the cylinder 12, respectively. The travelling mechanism with track 13 is connected with the base plate 11.

As shown in FIG. 2, the travelling mechanism with track 13 include a track 131, a track pulley 132, a track pulley support 133, and a driving mechanism14 that is fixed on the base plate 11. The track pulley support 133 is fixedly connected to the base plate 11. The track pulley 132 is disposed on the track pulley support 133. The track 131 is disposed on the track pulley 132. The driving mechanism14 transmits to connect with the track pulley 132. The driving mechanism 14 can be a motor, an engine, or any driving device that can drive the movement of the track pulley.

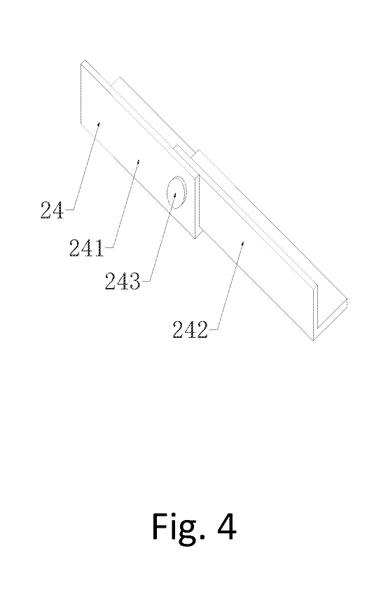

As shown in FIGS. 1 and 4, the foldable pole 24 includes a first folding board 241, and a second folding board 242. One end of the first folding board 241 is hinged with one end of the second folding board 242 through a hinge axis 243. Another end of the first folding board 241 and another end of the second folding board 242 are hinged with the sleeve 21, respectively. In an embodiment, the first folding board 241 and the second folding board 242 are made from L-shaped steel plate. When the first folding board 241 and the second folding board 242 are unfolded, the two L-shaped steel plates abut each other such that the function of the telescopic device 2 is achieved.

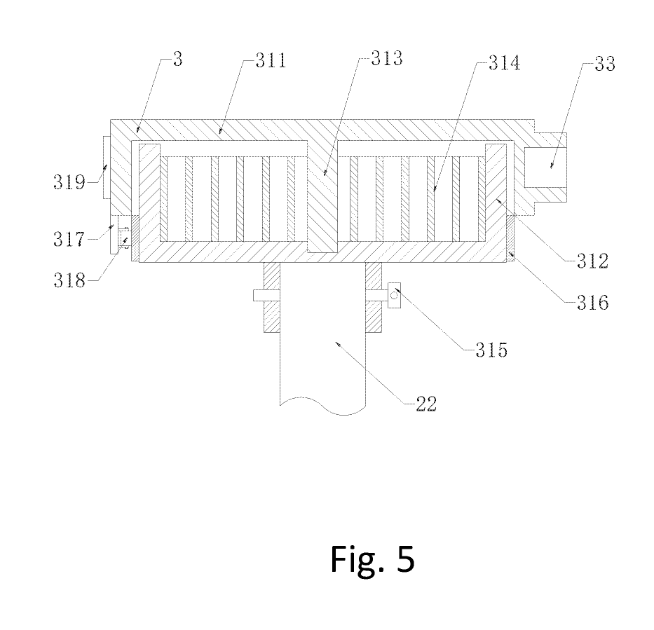

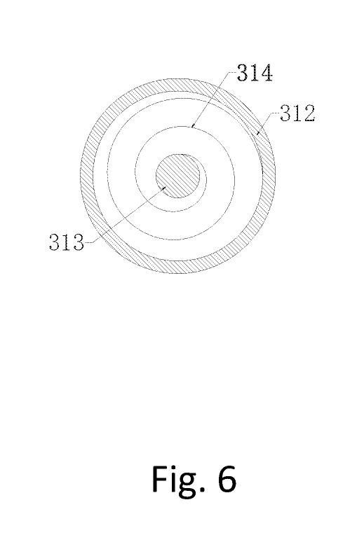

As shown in FIGS. 5 and 6, the damped turntable 3 includes a fixed chassis 312, a rotating disk 311 and a winding spring 314. The fixed chassis 312 is connected to the movable rod 22 through a plug 315. The fixed chassis 312 is rotably connected to the rotating disk 311 through a shaft 313 disposed on the rotating disk 311. The winding spring 314 is disposed in the cavity between the fixed chassis 312 and the rotating disk 311. One end of the winding spring 314 is fixedly connected to the fixed chassis 312. Another end of the winding spring 314 is fixedly connected to the shaft 313. The winding spring 314 elastically deforms when the rotating disk 311 rotates, and the elastic force converts into a resistance against rotation of the video camera, so as to prevent the jittering caused by the sudden rotation. In an embodiment, the shaft 313 and the rotating disk 311 are one-piece structure.

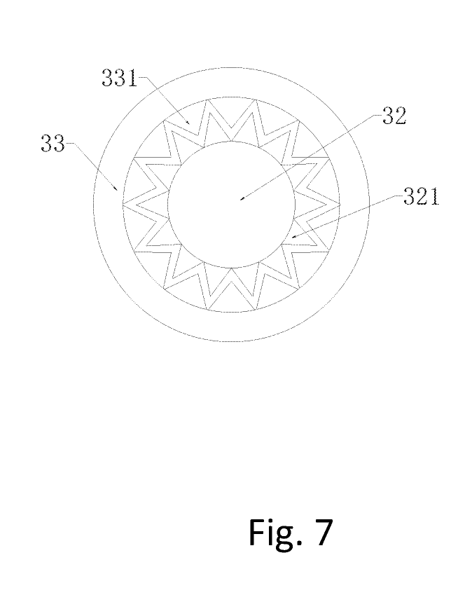

As shown in FIG. 7, the rotating disk 311 is provided with a connecting hole 33 that is used to connect a handle 32. A first tooth socket 331 is disposed in the connecting hole 33. One end of the handle 32 that connects to the connecting hole 33 is provided with a second tooth socket 321. The first tooth socket 331 mesh with the second tooth socket 321. The handle 32 connects to the rotating disk 311. The handle 32 is pushed to control the direction and speed of the rotation of the rotating disk 311.

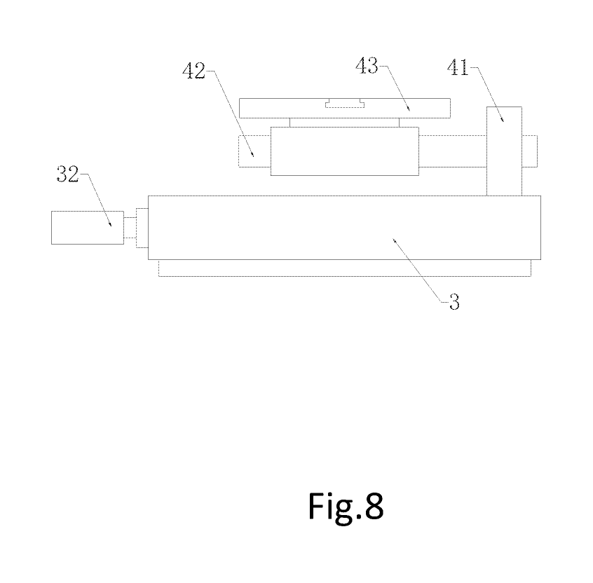

As shown in FIG. 8, the mounting bracket 4 includes a support plate 41 vertically fixed on the rotating disk 311, a transversely-arranged damped axis 42, and a mounting plate 43. One end of the damped axis 42 is connected to the support plate 41. Another end of the damped axis 42 is fixedly connected to the mounting plate 43.

The fixed chassis 312 is provided with a pressure-sensitive display 316. The rotating disk 311 is provided with a protrusion 317. The protrusion 317 is provided with a runner 318 that abuts the pressure-sensitive display 316. The rotating disk 311 is provided with a liquid crystal display 319. The pressure-sensitive display 316 and the liquid crystal display 319 are connected to external display controllers, respectively.

In an embodiment, the pressure-sensitive display 316 is a curved screen disposed on the outer circumferential surface of the fixed chassis 312. In another embodiment, the pressure-sensitive display 316 is disposed on the upper end surface of the fixed chassis 312.

The inductive and multi-view virtual reality panoramic video recording platform with a travelling mechanism of the invention includes a base, a telescopic device, a damped turntable, and an amounting bracket. The base includes a base plate, a cylinder that connects to the base plate, and a travelling mechanism with track. The travelling mechanism with track moves the entire platform. The base plate connects to the cylinder. The base can be fold or unfold by the movement of the cylinder. The telescopic device easily adjusts the height of the damped turntable. A winding spring is disposed in the damped turntable to generate a certain damping to the rotation of the camera in the horizontal direction. A damped shaft on the mounting bracket connects to the camera, generating a certain damping to the rotation of the camera in the vertical direction. The damping in the horizontal and vertical directions prevents the camera from shaking significantly when the camera is operated. In addition, the damped turntable is provided with a pressure-sensitive display. The pressure-sensitive display detects the rotation angle of the damped turntable and show the result on the liquid crystal display. Users do not need to read the rotation angle by the scale. It has advantages of having simple and reasonable structures, being easy to use and put away, and portable. It effectively solves the problem regarding the inconvenience of existing camera devices during travelling shot.

The exemplary embodiments of the present invention are thus fully described. Although the description referred to particular embodiments, it will be clear to one skilled in the art that the present invention may be practiced with variations of these specific details. Hence this invention should not be construed as limited to the embodiments set forth herein.

What is claimed is:

1. An inductive and multi-view virtual reality panoramic video recording platform with a travelling mechanism, comprising: a base 1, a telescopic device 2, a damped turntable 3 and a mounting bracket 4;
wherein the base includes a base plate 11, a cylinder 12 and a travelling mechanism with track 13; the base plate 11 is fixedly disposed at two ends of the cylinder 12, respectively; the travelling mechanism with track 13 is connected with the base plate 11,
wherein the telescopic device 2 includes a sleeve 21 that is fixed on the base 1, a movable rod 22 sleeved with a sleeve 21, a mounting bolt 23, and a foldable pole 24; the movable rod 22 is provided with a plurality of first bolt holes 25; the sleeve 21 is provided with second bolt holes 26 that correspond to the first bolt holes 25; the mounting bolt 23 passes through the first bolt hole 25 and the second bolt hole 26 to fix the sleeve 21 and the movable pole 22,
wherein the damped turntable 3 includes a fixed chassis 312, a rotating disk 311 and a winding spring 314; the fixed chassis 312 is connected to the movable rod 22 through a plug 315; the fixed chassis 312 is rotably connected to the rotating disk 311 through a shaft 313 disposed on the rotating disk 311;
the winding spring 314 is disposed in the cavity between the fixed chassis 312 and the rotating disk 311; one end of the winding spring 314 is fixedly connected to the fixed chassis 312; another end of the winding spring 314 is fixedly connected to the shaft 313,
wherein the mounting bracket 4 includes a support plate 41 vertically fixed on the rotating disk 311, a transversely-arranged damped axis 42, and a mounting plate 43; one end of the damped axis 42 is connected to the support plate 41; another end of the damped axis 42 is fixedly connected to the mounting plate 43,
wherein the fixed chassis 312 is provided with a pressure-sensitive display 316; the rotating disk 311 is provided with a protrusion 317; the protrusion 317 is provided with a runner 318 that abuts the pressure-sensitive display 316; the rotating disk 311 is provided with a liquid crystal display 319;
the pressure-sensitive display 316 and the liquid crystal display 319 are connected to external display controllers, respectively,

2. The inductive and multi-view virtual reality panoramic video recording platform with a travelling mechanism of claim 1, wherein the travelling mechanism with track 13 include a track 131, a track pulley 132, a track pulley support 133, and a driving mechanism 14 that is fixed on the base plate 11; the track pulley support 133 is fixedly connected to the base plate 11; the track pulley 132 is disposed on the track pulley support 133; the track 131 is disposed on the track pulley 132; the driving mechanism 14 transmits to connect with the track pulley 132.

3. The inductive and multi-view virtual reality panoramic video recording platform with a travelling mechanism of claim 1, wherein a chute is vertically disposed in the sleeve 21; a sliding block that is adapted to the chute is vertically disposed on the movable rod 22.

4. The inductive and multi-view virtual reality panoramic video recording platform with a travelling mechanism of claim 1, wherein the sleeve 21 is made from carbon structural steel; the movable rod 22 is made from magnetized carbon structural steel.

5. The inductive and multi-view virtual reality panoramic video recording platform with a travelling mechanism of claim 3, wherein the foldable pole 24 includes a first folding board 241, and a second folding board 242; one end of the first folding board 241 is hinged with one end of the second folding board 242 through a hinge axis 243; another end of the first folding board 241 and another end of the second folding board 242 are hinged with the sleeve 21, respectively.

6. The inductive and multi-view virtual reality panoramic video recording platform with a travelling mechanism of claim 3, wherein the first folding board 241 and the second folding board 242 are made from L-shaped steel plate.

7. The inductive and multi-view virtual reality panoramic video recording platform with a travelling mechanism of claim 3, wherein the shaft 313 and the rotating disk 311 are one-piece structure.

8. The inductive and multi-view virtual reality panoramic video recording platform with a travelling mechanism of claim 3, wherein the rotating disk 311 is provided with a connecting hole 33 that is used to connect a handle 32; a first tooth socket 331 is disposed in the connecting hole 33.

9. The inductive and multi-view virtual reality panoramic video recording platform with a travelling mechanism of claim 3, wherein one end of the handle 32 that connects to the connecting hole 33 is provided with a second tooth socket 321, the first tooth socket 331 mesh with the second tooth socket 321.
